(19) United States
(12) Patent Application Publication
(10) Pub. No.: US 2026/0208149 A1
(43) Pub. Date: Jul. 23, 2026

(54) POLYMER-BASED PACKING WITH LATTICE STRUCTURES FOR ROTATING PACKED BED

(71) Applicant: Hindustan Petroleum Corporation Limited, Bengaluru (IN)

(72) Inventors: Megha Sahu, Bengaluru (IN); Pawan Verma, Bengaluru (IN); Vijaya Durga Kakara, Bengaluru (IN); Yogesh Popatrao Patil, Bengaluru (IN); Annaji Rajiv Kumar Tompala, Bengaluru (IN); Bennet Chelliahn, Bengaluru (IN); Srinivasa Narasimha Sheshachala, Bengaluru (IN)

(21) Appl. No.: 19/088,932

(22) Filed: Mar. 24, 2025

(30) Foreign Application Priority Data
Jan. 20, 2025 (IN) 202541004525

(51) Int. Cl. B01J 19/32; B33Y 10/00; B33Y 80/00

(52) U.S. Cl. CPC B01J 19/32; B01J 2219/30249; B01J 2219/30466; B01J 2219/318; B33Y 10/00; B33Y 80/00

(57) ABSTRACT

A packaging for a rotating packed bed and a method for fabricating a packing for a rotating packed bed. The packaging comprises a polymer material and a lattice structure formed by one or more unit cells configured in a altered FCC arrangement. The lattice comprising of altered FCC unit cells can be extended to a predetermined size for an increased surface area for mass transfer within the rotating packing bed.

### CROSS REFERENCE TO RELATED APPLICATIONS

The present application claims the benefit of Indian Patent Application number 202541004525 filed on Jan. 20, 2025, the contents of which are incorporated herein by reference in their entirety.

### TECHNICAL FIELD

The present disclosure relates generally to rotating packed bed devices. More particularly, the present disclosure pertains to a polymer based packing with lattice structures for a rotating packed bed having high surface area to improve the gas separation efficiency with low pressure drop. The produced packaging for rotating packing bed having low cost, light weight and resistance to corrosion.

### BACKGROUND

In various industrial processes, such as chemical and environmental engineering applications, efficient mass transfer is crucial for operations like gas absorption, distillation, and solvent extraction. Traditional packed beds, which use random or structured packing materials, are often employed to facilitate mass transfer between phases (such as gas and liquid) by maximizing the contact area. However, conventional packed bed designs can suffer from limitations like high pressure drops, reduced efficiency, and limited operational flexibility, especially when high mass transfer rates are required. To overcome these limitations, rotating packed beds (RPBs) have been developed, which utilize centrifugal forces to enhance mass transfer rates and achieve higher operational efficiency in a compact design.

Rotating packed beds often incorporate metal-based packing materials to provide structural stability and high surface area. While effective in many applications, metal packings can be heavy, expensive, and challenging to fabricate in complex geometries. Additionally, metal materials may be prone to corrosion when exposed to certain chemicals and moisture, limiting their longevity and increasing maintenance costs in aggressive environments.

Recent advances in materials science and manufacturing techniques, particularly with polymers and additive manufacturing, have opened new possibilities for designing lighter, more cost-effective packing materials with tailored properties such as surface area, pore diameter, pore density etc., for improved performance in RPB systems.

Polymer-based packings offer several advantages over traditional metal packings, including reduced weight, lower manufacturing cost, and improved corrosion resistance. However, polymers have not been widely used in rotating packed beds due to limitations in achieving the complex geometries needed for optimal mass transfer.

There is, therefore, a need to provide an efficient solution of packing configuration for RPBs formed of a polymer material with a unique lattice structure to increase the surface area for mass transfer while maintaining structural stability under high-speed rotational conditions. In addition, there is a need for RPBs with reduced weight, lower cost and enhanced corrosion resistance.

### OBJECTS OF THE PRESENT DISCLOUSRE

An object of the present disclosure is to tailor the design within a rotating packing bed to improve mass transfer efficiency.

An object of the present disclosure is to achieve specific geometric configurations that enhance the surface area and mass transfer/separation capabilities of the packing.

An object of the present disclosure is to fabricate complex lattice structures with high precision, enabling the production of custom, high-performance rotating packing bed packing.

An object of the present disclosure is to fabricate polymer based rotating packing bed packing with light weight and corrosion resistant materials.

### SUMMARY

Aspects of the present disclosure relate to rotating packed bed devices. More particularly, the present disclosure pertains to a packing for a rotating packed bed and a method for fabricating a rotating packing bed with a high surface area lattice structures to improve mass transfer/separation efficiency and pressure drop. The method for fabricating the packing use advanced additive manufacturing techniques like Multi-Jet Fusion (MJF), Selective Laser Sintering (SLS), Digital Light Processing (DLP), Stereolithography (SLA), Material Jetting (MJ), Deposition Modeling (FDM) and Fused Granulated Fabrication (FGF) to improve mass transfer efficiency, reduce pressure drop, and enhance structural stability compared to conventional metal-based packings.

In an aspect, the disclosed packing for a rotating packed bed includes a polymer material and a lattice structure formed by one or more unit cells configured in a face centered cubic (FCC) arrangement with unique features such as struts and surfaces. Th struts extend from the center of each face to center of adjacent face. Each face has 4 struts extending from its center to the center of four adjacent faces. Each of these struts have extended surfaces in the parallelepiped shape to enhance the surface area for effective mass transfer within the rotating packing bed. Apart from cubic base unit cell, other base unit cell that can be used include tetragonal and orthorhombic. The size of unit cell can be tailored to a chosen value for a desired surface area to improve mass transfer rate and reduced pressure drop within the rotating packing bed.

The polymer material may be selected from Polyolefins such as polypropylene (PP), Polyethylene (PE), and their copolymers, Acrylonitrile Butadiene Styrene (ABS), Polylactic Acid (PLA), Polyethylene Terephthalate Glycol (PETG), Polycarbonate (PC), Photopolymers, Thermoplastic Polyurethane (TPU), Polyether ether ketone (PEEK), Polyether ketone ketone (PEKK), Polyarylether ketone (PAEK), Polyetherimide (PEI), Polysulfone (PSU) and Polyphenylsulfone (PPSU), Carbon Fiber-Reinforced Polymers, Glass Fiber-Reinforced Polymers, Carbon/Glass Fiber Modified polymers, Polyamides such as Nylon 6, Nylon 11 & Nylon 12 (PA12), or combinations thereof.

The lattice structure may be fabricated using one or more additive manufacturing techniques for a specific geometric configuration. The additive manufacturing techniques may include Multi-Jet Fusion (MJF), Selective Laser Sintering (SLS), Digital Light Processing (DLP), Stereolithography (SLA), Material Jetting (MJ), Fused Deposition Modeling (FDM) and Fused Granulated Fabrication (FGF).

The lattice configuration may have the surface area in the range of 500 to 1500 m²/m³.

The predetermined value can be based on one or more operational parameters selected from the group consisting of rotational speed of the rotating packed bed, volumetric flow rate of the fluid, temperature, pressure, and viscosity of the fluid.

In an another aspect, the disclosed method for fabricating a packing for a rotating packed bed. The method may include creating a 3-dimensional model of unit cells configured in a modified FCC lattice structure, where the structure having a configuration to increase surface area for mass transfer within the structure and fabricating the structure using a 3D printing technique using a polymer material.

The polymer material used for 3D printing may be Polyolefins such as polypropylene (PP), Polyethylene (PE), and their copolymers, Acrylonitrile Butadiene Styrene (ABS), Polylactic Acid (PLA), Polyethylene Terephthalate Glycol (PETG), Polycarbonate (PC), Photopolymers, Thermoplastic Polyurethane (TPU), Polyether ether ketone (PEEK), Polyether ketone ketone (PEKK), Polyarylether ketone (PAEK), Poly Polyetherimide (PEI), Polysulfone (PSU) and Polyphenylsulfone (PPSU), Carbon Fiber-Reinforced Polymers, Glass Fiber-Reinforced Polymers, Glass/Carbon Fiber Modified Polymers or combinations thereof.

The 3D printing technique may be selected from Multi-Jet Fusion (MJF), Selective Laser Sintering (SLS), Digital Light Processing (DLP), Stereolithography (SLA), Material Jetting (MJ) and Fused Deposition Modeling (FDM)

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIGS. 1(a)-1(b) illustrate a basic unit cell and an altered face centered cubic unit cell, in accordance with an embodiment of the present disclosure.

FIGS. 2(a)-2(c) illustrate exemplary representations of the proposed packing, in accordance with an embodiment of the present disclosure.

FIGS. 3(a)-3(d) illustrate exemplary representations of different configurations of unit cells with different surface areas, in accordance with an embodiment of the present disclosure.

FIGS. 4(a)-4(c) illustrate exemplary representations of different configurations after printability study, in accordance with an embodiment of the present disclosure.

FIG. 5 illustrates an exemplary flow diagram for implementing the steps of the proposed method, in accordance with an embodiment of the present disclosure.

FIGS. 6(a) and 6(b) depict a comparison of CO₂ separation performance between polypropylene (PP) packing and metal foam packing in a rotating packed bed under two different conditions of low CO₂ feed and high CO₂ feed, in accordance with an embodiment of the present disclosure.

FIGS. 7(a) and 7(b) depict a comparison of CO₂ separation performance between PA12 packing and metal foam packing in a rotating packed bed under two different conditions of low CO₂ feed and high CO₂ feed, in accordance with an embodiment of the present disclosure.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Embodiments explained herein relate to a packing for a rotating packed bed and a method for fabricating a rotating packing bed with a high surface area using altered FCC lattice structure to improve mass transfer rate and reduce pressure drop.

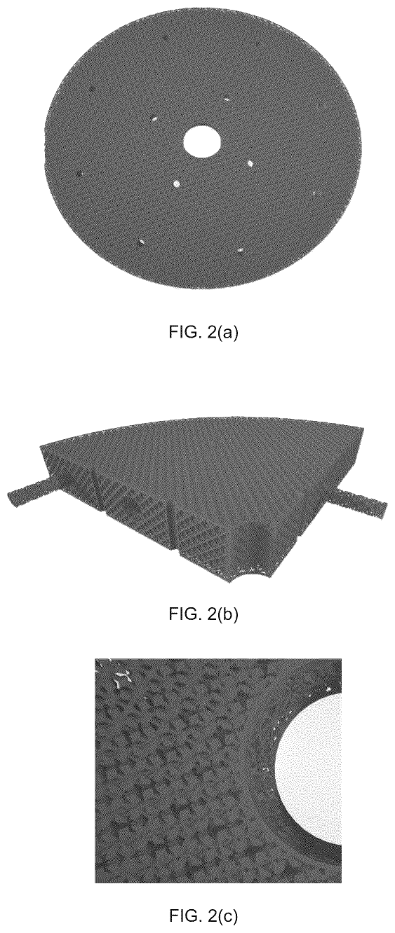

Referring to FIGS. 2(a)-2(c), the proposed packaging for a rotating bed is disclosed. The packaging can include a polymer material and a lattice structure formed by one or more unit cells configured in an altered FCC unit cell. The altered FCC unit cell shape and size can be extended to a predetermined value for an increased surface area for mass transfer rate within the rotating packing bed.

In an embodiment, the polymer material can be selected from polyolefins such as polypropylene (PP), Polyethylene (PE), and their copolymers, Acrylonitrile Butadiene Styrene (ABS), Polylactic Acid (PLA), Polyethylene Terephthalate Glycol (PETG), Polycarbonate (PC), Photopolymers, Thermoplastic Polyurethane (TPU), Polyether ether ketone (PEEK), Polyether ketone ketone (PEKK), Polyarylether ketone (PAEK), Polyetherimide (PEI), Polysulfone (PSU) and Polyphenylsulfone (PPSU), Carbon Fiber-Reinforced Polymers, Glass Fiber-Reinforced Polymers, Glass/Carbon Fiber Modified Polymers, Polyamides such as Nylon 6, Nylon 11 & Nylon 12 (PA12), or combinations thereof.

In an embodiment, the lattice structure can be fabricated using one or more additive manufacturing techniques for a specific geometric configuration. The additive manufacturing techniques can be Multi-Jet Fusion (MJF), Selective Laser Sintering (SLS), Digital Light Processing (DLP), Stereolithography (SLA), Material Jetting (MJ), Fused Deposition Modeling (FDM) and Fused Granulated Fabrication (FGF).

In an example, Multi-Jet Fusion (MJF) is an advanced 3D printing technology that utilizes an inkjet-like process to selectively apply a binding agent onto a powder bed, which is then fused by applying heat. MJF prints parts layer by layer, with each layer consisting of a powder bed. A binding agent is applied to the powder to form the desired shape. After the binder is applied, heat is used to fuse the powder material together, forming solid parts. This is done using a heat source, which is typically an infrared lamp.

In an example, Selective Laser Sintering (SLS) is an additive manufacturing (3D printing) technique that uses a high-powered laser to selectively fuse powdered material, layer by layer, to create solid parts. SLS uses a bed of fine powder, typically made from materials like nylon (PA), polyolefins, metal, or elastomers. Each layer of powder is spread evenly across the build platform, and a laser selectively sinters (melts) the powder particles together to form a solid part. A high-powered laser, usually a CO₂ laser, is directed at specific areas of the powder bed based on the 3D model. The laser melts and fuses the powdered particles, binding them together to form a solid layer. After one layer is completed, the next layer of powder is spread over the surface, and the process repeats.

In an example, Digital Light Processing (DLP) is a projection and imaging technology that uses micro-mirrors to manipulate light with high precision. A lamp, LED, or laser generates the light, a DMD chip reflects the light in specific patterns based on the desired image or data, a color is achieved using a spinning color wheel (in projection systems) or direct RGB light sources. The mirrors rapidly alternate between colors to create the full spectrum. The modulated light is projected through a lens onto a screen, surface, or object.

In an example, Stereolithography (SLA) is a 3D printing technology that uses a laser or other focused light source to solidify liquid resin into a solid object, layer by layer. SLA uses a vat filled with liquid photopolymer resin, which hardens when exposed to a specific wavelength of light (typically ultraviolet or near-ultraviolet). A highly focused laser beam or light source selectively cures the resin, tracing the pattern of a single layer based on the digital design. Once a layer is cured, the build platform either moves up (top-down SLA) or down (bottom-up SLA) by a small increment, allowing uncured resin to flow over the previously solidified layer. The process repeats, stacking layers until the entire object is formed. After printing, the object is removed from the platform, cleaned (usually in isopropyl alcohol) to remove excess resin, and cured further using UV light for additional strength and stability.

In an example, Material Jetting (MJ) is an additive manufacturing (3D printing) technology that selectively deposits liquid photopolymer droplets onto a build platform and then cures them using UV light. MJ use printheads with tiny nozzles spray liquid photopolymer material in precise locations on the build platform, each deposited layer is immediately cured (hardened) using ultraviolet (UV) light, ensuring stability before the next layer is applied and platform lowers incrementally, and new layers are jetted and cured until the complete object is formed.

In an example, Fused Deposition Modeling (FDM) creates 3D objects by extruding thermoplastic material through a heated nozzle, depositing it layer by layer in a predetermined pattern. FDM includes a spool of thermoplastic filament is loaded into the printer and filament is fed into a heated extruder where it is melted. The melted material is extruded through a nozzle and deposited onto the build platform. The printer's gantry system moves the nozzle in the X, Y, and Z directions to trace the object's shape layer by layer. As the material cools, it solidifies and bonds to the previous layer.

In an example, Fused Granulated Fabrication (FGF) is a form of additive manufacturing (3D printing) that uses granulated thermoplastics instead of filament as the raw material. Granules are melted in a heated extrusion system, molten plastic is deposited layer by layer onto the build platform, following a digital CAD model and each layer is cooled and solidified before the next one is deposited, ensuring proper adhesion and structural integrity.

In an embodiment, the lattice configuration with altered FCC unit cells has the surface area in the range of 500 to 1500 m²/m³.

In an embodiment, the predetermined value of surface area can be based on one or more operational parameters selected from the group consisting of rotational speed of the rotating packed bed, volumetric flow rate of the fluid, temperature, pressure, and viscosity of the fluid.

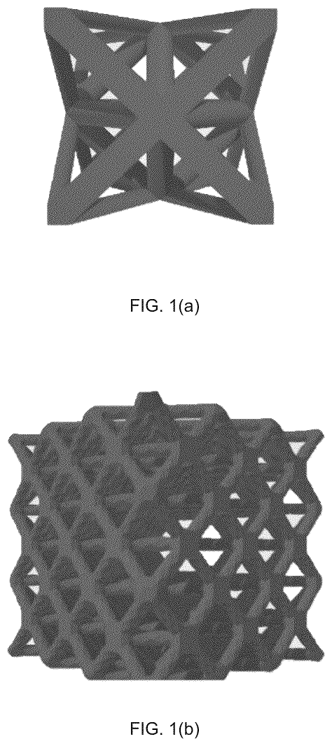

The structure can be altered FCC unit cell consisting of intersecting struts forming a lattice. Th struts extend from the center of each face to center of adjacent face. Each face has 4 such struts extending from its center to the center of four adjacent faces. Each of these struts have extended surfaces in the parallelepiped shape to enhance the surface area for effective mass transfer within the rotating packing bed. The compact arrangement maximizes the surface-to-volume ratio. Each unit cell can be approximately in the range 5-15 mm in size. The surface area per unit volume can be 500-1500 m²/m³, highlighting the significant surface availability for applications requiring enhanced contact or mass transfer efficiency. (a shown in FIGS. 1(a) and 1(b))

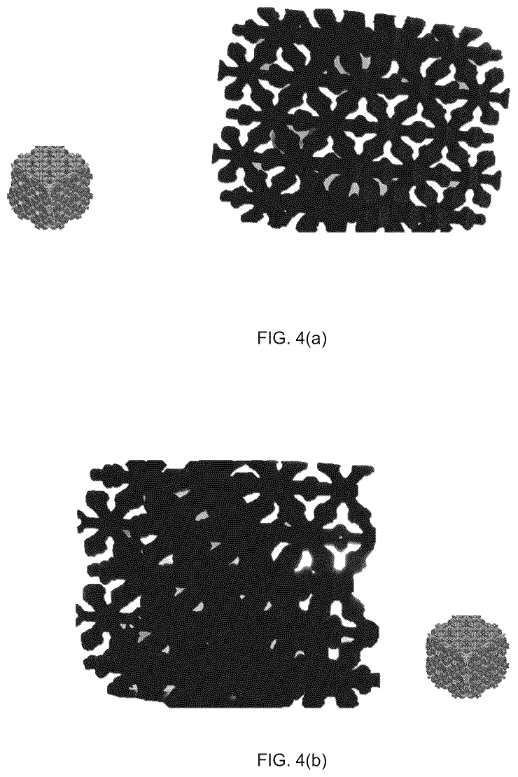

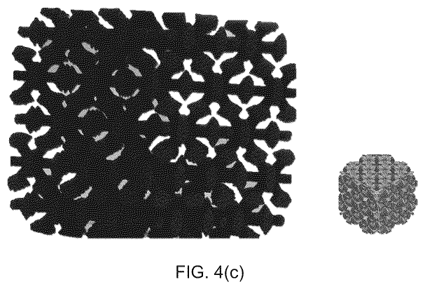

The altered face centered cubic (FCC) arrangement has unique features such as struts and surfaces. The struts extend from the center of each face to center of adjacent face. Each face has 4 struts extending from its center to the center of four adjacent faces. The struts enhance the interstitial space, surface area, or mechanical strength. The network of interlinked patterns such as struts and extended surfaces, significantly increase the potential surface interactions by maximizing geometric intricacy, leading to better mass transfer or structural rigidity. (as shown in FIGS. 4(a)-4(c)). Apart from cubic base unit cell, other base unit cell that can be used include tetragonal and orthorhombic.

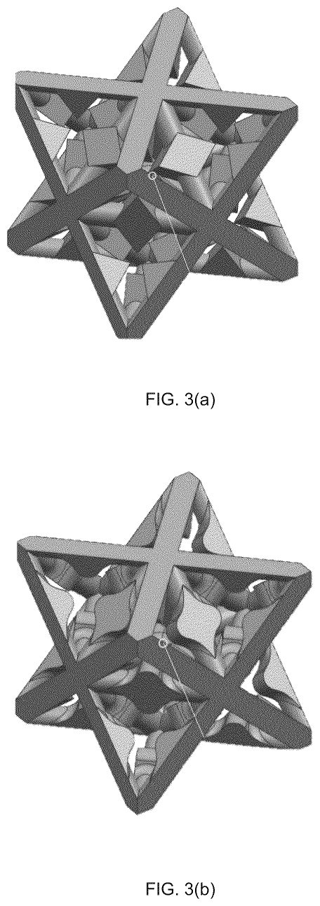

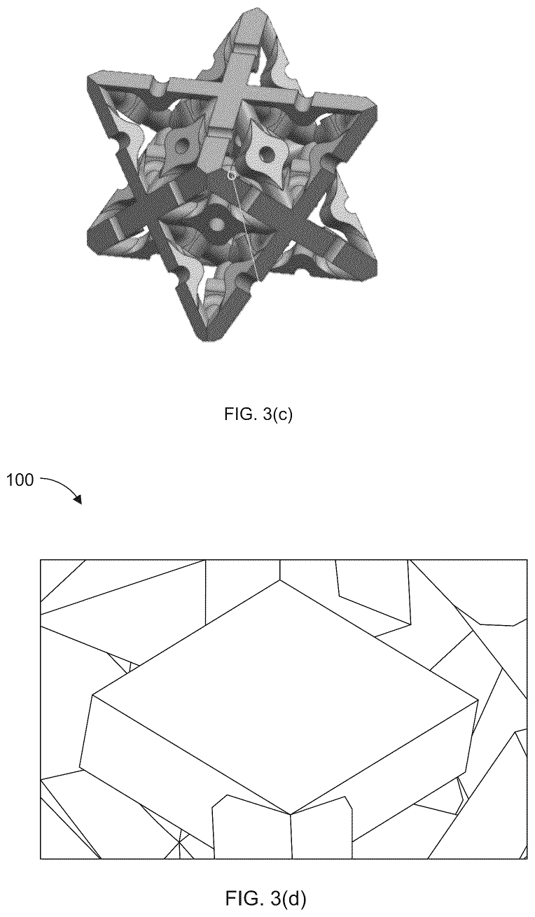

There are three variation of the unit cells. Each unit cell differ from the other unit cell in terms of shape and size of the extended surfaces of struts. The first unit cell as shown in FIG. 3(a) has extended surfaces of the struts in the shape of a parallelepiped. The angle between the walls of parallelepiped are ~109 and 70 degrees (as shown in FIG. 3(d). The second unit cell is shown in FIG. 3(b) differs from first unit cell as the two walls of the parallelepiped are merged to form a unified curved surface. The third unit cell is shown in FIG. 3(c) differs from second unit cell with additional hole in the center of extended surface to reduce the weight and density of the final part along with enhanced effective surface area.

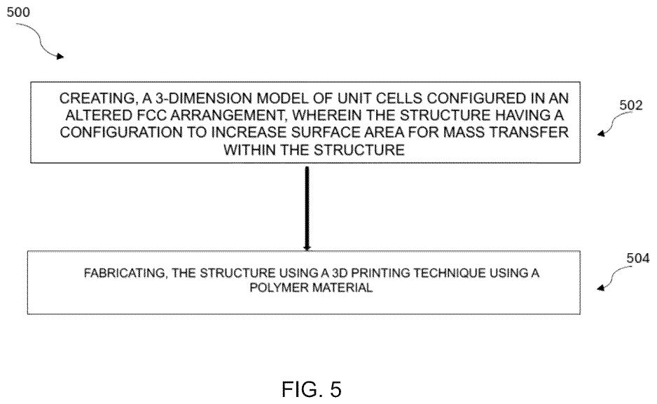

Referring to FIG. 5, method 500 for fabricating a packing for a rotating packed bed is disclosed. Method 500 can include a step 502 of creating a 3-dimension model of unit cells configured in an altered FCC arrangement, where the structure can have a configuration to increase surface area for mass transfer within the structure. Further, the method 500 can include a step 504 of fabricating the structure using a 3D printing technique using a polymer material.

In an exemplary embodiment, the fabrication of a packing disc is done using two types of polymers, Polypropylene (PP) and Polyamide 12 (PA12). The unit cell as shown in FIG. 3(a) is used for both PP and PA12 packing. For the designing of unit cell, Siemens Nx software was used. For designing packing 3D model by replication of unit cell in packing geometry was done using Design X. The unit cell size used was 12 mm. The developed 3D model is fabricated using multi-jet fusion additive manufacturing technology. The HP Multi Jet Fusion (MJF) process is a powder-based additive manufacturing technique that builds complex 3D structures layer by layer. It uses inkjet arrays to apply fusing and detailing agents to powdered material, which is then fused with heat to form solid layers. This process offers high speed, precision, and the ability to create intricate parts.

Example 1: Fabrication of Polypropylene Packing: The fabrication of PP packing is done using the 3D model consisting of unit cell as shown in image 3(a) with a unit cell size of 12 mm. The packing is fabricated using multi-jet fusion equipment-HP 5200 with build volume: 380 mm×284 mm×380 mm. The PP material used has the following properties:

TABLE 1
Properties of PP material

| | Average (XY) | Average Z | Test Method |
|---|---|---|---|
| Tensile strength (MPa) | 29 | 29 | ASTM D638 |
| Tensile modulus (MPa) | 1600 | 1600 | ASTM D638 |
| Heat deflection | 100 | 100 | ASTM D648 |
| temperature | | | |
| [@ 0.45 MPa, 66 psi] | | | |
| (° C.) | | | |
| Heat deflection | 60 | 60 | ASTM D648 |
| temperature | | | |
| [@ 1.82 MPa, 264 psi] | | | |
| (° C.) | | | |
| Elongation at yield (%) | 9.5 | 9.5 | ASTM D638 |
| Elongation at break (%) | 20 | 14 | ASTM D638 |
| Impact strength (kJ/m2) | 3.5 | 3.0 | ASTM D256 |
| Density (g/cm3) | 0.87 | 0.87 | ASTM D792 |

Example 2: Fabrication of Polyamide 12 packing: The fabrication of PA12 packing is done using the 3D model consisting of unit cell as shown in image 3(a) with a unit cell size of 12 mm. The packing is fabricated using multi-jet fusion equipment-HP 5200. The layer thickness of approximately 0.08 mm is used. Its processing temperature ranges from 160-180° C., slightly below its melting point of 186° C. The PA12 material has the following properties:

TABLE 2
Properties of PA12 material

| | Average (XY) | Average Z | Test Method |
|---|---|---|---|
| Tensile strength (MPa) | 48 | 48 | ASTM D638 |
| Tensile modulus (MPa) | 1700 | 1800 | ASTM D638 |
| Heat deflection | 175° C. | 175 | ASTM D648 |
| temperature | | | |
| [@ 0.45 MPa, 66 psi] | | | |
| (° C.) | | | |
| Heat deflection | 95 | 106 | ASTM D648 |
| temperature | | | |
| [@ 1.82 MPa, 264 psi] | | | |
| (° C.) | | | |
| Elongation at yield (%) | 20 | 15 | ASTM D638 |
| Elongation at break (%) | 20 | 15 | ASTM D638 |
| Density (g/cm3) | 0.87 | 0.87 | ASTM D792 |

In an example, the evaluation of PP packing is conducted in a rotating packed bed. The rotating packed bed is used for separation of CO₂ using the amine solvents. The PP packing evaluation is compared against metal foam. There are two conditions used for testing and evaluation.

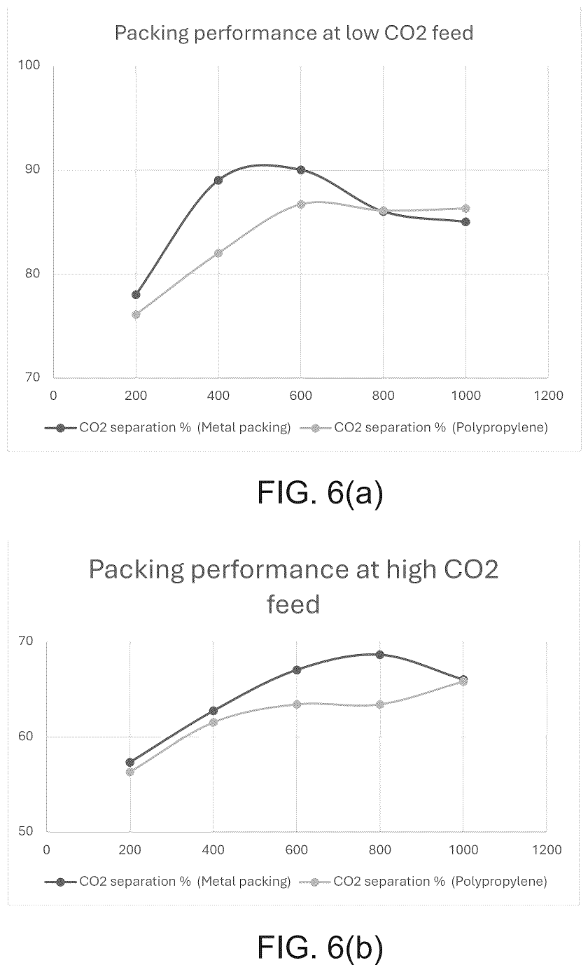

Condition 1: Low CO₂ feed (as shown in FIG. 6(a))—This graph evaluates CO₂ separation efficiency (%) at low CO₂ feed under varying operating conditions, likely reflecting different gas or liquid flow rates. Both metal packing and polypropylene packing show an increasing trend in CO₂ separation efficiency initially, peaking around 600 units on the x-axis, and then declining slightly. Metal packing achieves higher separation efficiency compared to polypropylene packing and peaks around 92% efficiency, in contrast, the polypropylene packing peaks at slightly lower efficiency around 88%. Metal packing consistently outperforms polypropylene packing, with a maximum difference at the peak efficiency regio

Condition 2: High CO₂ feed (as shown in FIG. 6(b))—This graph examines CO₂ separation efficiency at higher CO₂ feed conditions, with the same comparative framework between metal and polypropylene packing. Both materials exhibit a similar trend, with separation efficiency increasing initially and stabilizing between 600 and 800 units. Beyond this, metal packing shows a slight drop, while polypropylene packing remains stable. Metal packing peaks at a higher efficiency (approximately 68%) compared to polypropylene packing and polypropylene packing has a slightly lower peak efficiency (around 65%), with less performance drop-off at higher operational levels.

Overall CO₂ separation efficiency is higher under low CO₂ feed conditions for both packings. Metal packing consistently outperforms polypropylene packing under both conditions 1 and 2. The performance difference is more pronounced at low CO₂ feed compared to high CO₂ feed.

In an example, the evaluation of PA12 packing is conducted in a rotating packed bed. The rotating packed bed is used for separation of CO₂ using the amine solvents. The PA12 packing evaluation is compared against metal foam. There are two conditions used for testing and evaluation.

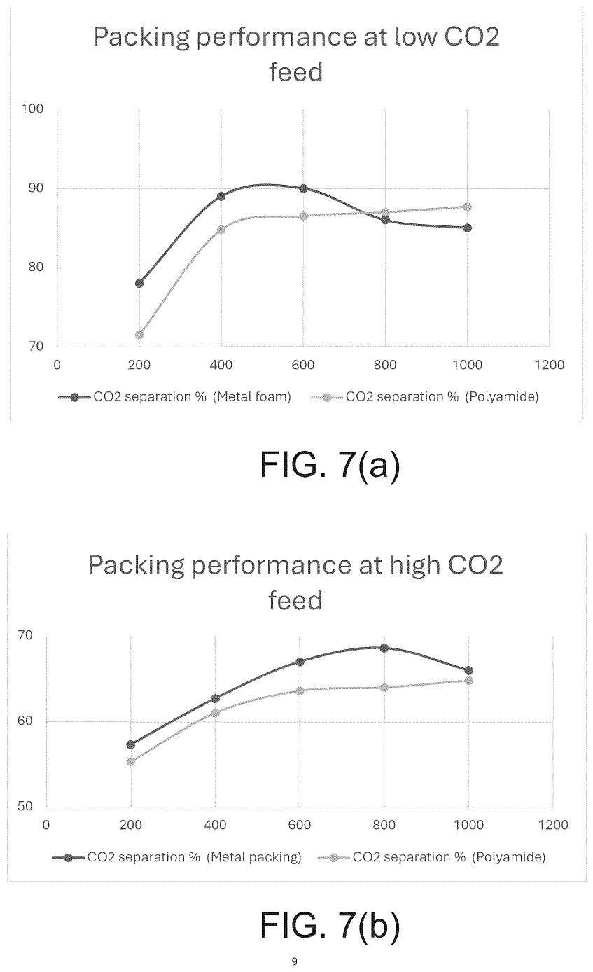

Condition 1: Low CO₂ feed (as shown in FIG. 7(a))—CO₂ separation percentage is higher for metal foam compared to PA12 packing across the tested range. For both packings, separation efficiency increases with feed rate up to approximately 400-600 units of feed, where it reaches a peak. After the peak, the separation efficiency starts to decline slightly for metal foam, in contrast, PA12 packing shows a more stable plateau or a slower decline. Metal foam exhibits superior performance under low CO₂ feed conditions, likely due to its inherent properties, such as higher surface area or better interaction with the amine solvent. PA12 packing demonstrates consistent separation performance but does not match the peak efficiency of metal foam.

Condition 2: High CO₂ feed (as shown in FIG. 7(b))—Similar to the low CO₂ feed case, metal packing outperforms PA12 packing in terms of separation percentage. Both packings show a steady increase in CO₂ separation efficiency with increasing feed rate up to around 600-800 units, where the performance peaks. Beyond this peak, the separation efficiency declines slightly for both packings, though metal packing maintains a marginally higher performance. At high CO₂ feed conditions, metal packing continues to outperform PA12 packing, indicating its better adaptability to increased CO₂ concentrations. PA12 packing shows stable performance but struggles to reach the efficiency levels of metal packing under high feed rates.

Overall, metal foam/metal packing demonstrates better CO₂ separation performance in both low and high feed conditions, which may be attributed to its structural and material properties. PA12 packing, while slightly less efficient, provides stable and consistent separation performance, making it a potential alternative under specific operational or cost constraints.

Thus, the present disclosure provides a polymer-based packing for rotating packed beds with an enhanced surface area using lattice structure with altered FCC unit cell. By leveraging 3D printing techniques for precise fabrication, the packing achieves superior performance characteristics, including improved mass transfer efficiency, reduced pressure drop, and enhanced chemical resistance.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides an extended surface area due to its lattice design with improved efficiency in mass transfer processes such as absorption, distillation, and chemical reactions.

The present disclosure provides increased surface area to enable better interaction between phases (gas-liquid, liquid-liquid), enhancing mass transfer rates compared to conventional metal packings.

The present disclosure provides a lattice structure that minimizes flow resistance, resulting in a lower pressure drop across the packing, which enhances energy efficiency in rotating packed bed systems.

The present disclosure provides a packing system which is corrosion resistant, light weight, easy to manufacture in various complex shapes, easy to assemble and can be fabricated locally.

We claim:

1. A packing for a rotating packed bed, comprising:
a lattice structure formed by one or more unit cells configured in an altered FCC arrangement,
wherein the altered FCC unit cells are extended to a predetermined shape for an increased surface area for effective mass transfer and separation of gases/liquid within the rotating packing bed.

2. The packing as claimed in claim 1, wherein the altered FCC unit cell consists of intersecting struts forming a lattice, the struts extend from the center of each face of the unit cell to center of adjacent face, and wherein there are three variation of the unit cells with each unit cell different from the other unit cell in shape and size of the extended surfaces of struts.

3. The packing as claimed in claim 1, wherein the polymer material is selected from polyolefins such as polypropylene (PP), Polyethylene (PE), and their copolymers, Acrylonitrile Butadiene Styrene (ABS), Polylactic Acid (PLA), Polyethylene Terephthalate Glycol (PETG), Polycarbonate (PC), Photopolymers, Thermoplastic Polyurethane (TPU), Polyether ether ketone (PEEK), Polyether ketone ketone (PEKK), Polyarylether ketone (PAEK), Polyetherimide (PEI), Polysulfone (PSU) and Polyphenylsulfone (PPSU), Carbon Fiber-Reinforced Polymers, Glass Fiber-Reinforced Polymers, Carbon/Glass Fiber Modified Polymers, Polyamides such as Nylon 6, Nylon 11 & Nylon 12 (PA12), or combinations thereof.

4. The packing as claimed in claim 1, wherein the lattice structure is fabricated using one or more additive manufacturing techniques for a specific geometric configuration.

5. The packing as claimed in claim 3, wherein the additive manufacturing techniques comprise Multi-Jet Fusion (MJF), Selective Laser Sintering (SLS), Digital Light Processing (DLP), Stereolithography (SLA), Material Jetting (MJ), Fused Deposition Modeling (FDM) and Fused Granulated Fabrication (FGF).

6. The packing as claimed in claim 1, wherein the altered FCC configuration has the surface area in the range of 500 to 1500 m²/m³.

7. The packing as claimed in claim 1, wherein the predetermined value of surface area is based on one or more operational parameters selected from the group consisting of rotational speed of the rotating packed bed, volumetric flow rate of the fluid, temperature, pressure, and viscosity of the fluid.

8. A method (500) for fabricating a packing for a rotating packed bed, comprising:
creating (502), a 3-dimension model of unit cells configured in an altered FCC arrangement, wherein the structure having a configuration to increase surface area for mass transfer within the structure; and
fabricating (504), the structure using a 3D printing technique using a polymer material.

9. The method (500) as claimed in claim 8, wherein the polymer material used for 3D printing is polyolefins such as polypropylene (PP), Polyethylene (PE), and their copolymers, Acrylonitrile Butadiene Styrene (ABS), Polylactic Acid (PLA), Polyethylene Terephthalate Glycol (PETG), Polycarbonate (PC), Photopolymers, Thermoplastic Polyurethane (TPU), Polyether ether ketone (PEEK), Polyether ketone ketone (PEKK), Polyarylether ketone (PAEK), Polyetherimide (PEI), Polysulfone (PSU) and Polyphenylsulfone (PPSU), Carbon Fiber-Reinforced Polymers, Glass Fiber-Reinforced Polymers, Carbon/Glass Fiber Modified Polymers, Polyamides such as Nylon 6, Nylon 11 & Nylon 12 (PA12), or combinations thereof.

10. The method (500) as claimed in claim 8, wherein the 3D printing technique is selected from Multi-Jet Fusion (MJF), Selective Laser Sintering (SLS), Digital Light Processing (DLP), Stereolithography (SLA), Material Jetting (MJ) and Fused Deposition Modeling (FDM) and Fused Granulated Fabrication (FGF).
